(19) United States
(12) Patent Application Publication
(10) Pub. No.: US 2024/0153241 A1
(43) Pub. Date: May 9, 2024

(54) CLASSIFICATION DEVICE, CLASSIFICATION METHOD, AND CLASSIFICATION PROGRAM

(71) Applicant: Nippon Telegraph and Telephone Corporation, Tokyo (JP)

(72) Inventors: Misa FUKAI, Musashino-shi, Tokyo (JP); Kimio TSUCHIKAWA, Musashino-shi, Tokyo (JP); Fumihiro YOKOSE, Musashino-shi, Tokyo (JP); Yuki Urabe, Musashino-shi, Tokyo (JP); Sayaka Yagi, Musashino-shi, Tokyo (JP); Haruo OISHI, Musashino-shi, Tokyo (JP)

(21) Appl. No.: 18/281,641

(22) PCT Filed: Mar. 17, 2021
(86) PCT No.: PCT/JP2021/010932

§ 371 Date: Sep. 12, 2023

(51) Int. Cl. G06V 10/764; G06F 3/04812; G06T 5/50

(52) U.S. Cl. CPC G06V 10/764; G06F 3/04812; G06T 5/50; G06T 2207/20221

(57) ABSTRACT

A classification device (10) acquires captured images of an operation screen before and after occurrence of an operation event of a terminal device. Then, the classification device (10) generates, as a difference image, a change occurring on the operation screen before and after the occurrence of the operation event by using the acquired captured image. Subsequently, the classification device (10) classifies the types of operated GUI components by using the generated difference image.

### TECHNICAL FIELD

The present invention relates to a classification device, a classification method, and a classification program.

### BACKGROUND ART

In the related art, in order to implement effective business improvement through robotic process automation (RPA) or the like, it is important to ascertain actual situations of business accurately and comprehensively. For example, as methods of ascertaining the actual situations of business, there are methods of collecting operations on graphic user interface (GUI) components operating on terminals (hereinafter referred to as terminal devices) of operators as operation logs and displaying the operation logs in flowchart formats.

As mechanisms acquiring operation logs with granularity of operations performed on GUI components by operators, for example, technologies for acquiring attribute values of GUI components of operation screens at the time of occurrence of operation events on the operation screens of GUI applications and identifying changed portions before and after the occurrence of the operation events are known.

### CITATION LIST

### Non Patent Literature

Non Patent Literature 1: Ogasawara et al., “Development of Business Process Visualization and Analysis System Utilizing Business Execution History”, NTT Technical Journal, 2009.2, P40-P43

### SUMMARY OF INVENTION

### Technical Problem

However, in the technologies of the related art, GUI components operated in execution environments of applications of terminal devices and types of GUI components cannot be easily identified in some cases. For example, methods of acquiring attribute values of GUI components may be different for each type or version of applications. Therefore, in order to acquire operation logs of all applications used in business, with development of functions of acquiring attribute values of GUI components and identifying changed portions according to execution environments of the applications, modification is required whenever specifications of the applications are changed, and there is a problem that the realization of these functions is expensive.

For example, business is not directly performed with terminal devices and is performed through connection from the terminal devices to thin client terminals in some cases. In these cases, since only image information can be transmitted from the thin client terminals to the terminal devices, there is a problem that it is difficult to identify information regarding GUI components operated on the thin client terminals and the changed portions when the technologies of the related art are used from the terminal devices.

Accordingly, the present invention has been made to solve the above-described problems of the related art, and an objective of the present invention is to easily identify an operated GUI component and the type of GUI component irrespective of an execution environment of an application of a terminal device.

### Solution to Problem

In order to solve the above-described problem and achieve the objective, according to an aspect of the present invention, a classification device includes; an acquisition unit configured to acquire captured images of an operation screen before and after occurrence of an operation event of a terminal device; a generation unit configured to generate, as a difference image, a change occurring on an operation screen before and after the occurrence of the operation event by using the captured images acquired by the acquisition unit; and a classification unit configured to classify types of GUI components operated in the operation event by using the difference image generated by the generation unit.

According to another aspect of the present invention, a classification method is executed by a classification device and includes an acquisition step of acquiring captured images of an operation screen before and after occurrence of an operation event of a terminal device; a generation step of generating, as a difference image, a change occurring on an operation screen before and after the occurrence of the operation event by using the captured images acquired in the acquisition step; and a classification step of classifying types of GUI components operated in the operation event by using the difference image generated in the generation step.

According to still another aspect of the present invention, a classification program causes a computer to execute: an acquisition step of acquiring captured images of an operation screen before and after occurrence of an operation event of a terminal device; a generation step of generating, as a difference image, a change occurring on an operation screen before and after the occurrence of the operation event by using the captured images acquired in the acquisition step; and a classification step of classifying types of GUI components operated in the operation event by using the difference image generated in the generation step.

### Advantageous Effects of Invention

According to the present invention, it is possible to easily identify an operated GUI component and the type of GUI component irrespective of an execution environment of an application of a terminal device.

### BRIEF DESCRIPTION OF DRAWINGS

FIG. 1 is a block diagram illustrating a configuration of a classification device according to a first embodiment.

FIG. 2 is a diagram illustrating an example of a difference image generated from a captured image before and after an operation of a GUI component which is a radio button.

FIG. 3 is a diagram illustrating an example of a difference image generated from a captured image before and after an operation of a GUI component of a check box.

FIG. 4 is a diagram illustrating an example of a difference image generated from a captured image before and after an operation of a GUI component of a pull-down menu.

FIG. 5 is a diagram illustrating an example of a difference image generated from a captured image before and after an operation of a GUI component of a text box.

FIG. 6 is a diagram illustrating an example of a difference image generated from a captured image before and after an operation of a GUI component of a button.

FIG. 7 is a diagram illustrating an example of a difference image generated from a captured image of the entire screen before and after an operation of a GUI component.

FIG. 8 is a diagram illustrating an example of a variation of input data for a learned model.

FIG. 9 is a diagram illustrating a process of classifying types of operated GUI components by inputting the captured image and the difference image to the learned model.

FIG. 10 is a flowchart illustrating an example of a process of storing a captured image for each operation event in the classification device according to the first embodiment.

FIG. 11 is a flowchart illustrating an example of a process of extracting an operation event on a GUI component from a captured image in the classification device according to the first embodiment.

FIG. 12 is a flowchart illustrating an example of a process of generating a difference image in the classification device according to the first embodiment.

FIG. 13 is a flowchart illustrating an example of a process of classifying GUI components from a captured image for each operation event in the classification device according to the first embodiment.

FIG. 14 is a diagram illustrating an example of a flow of a process of acquiring, inputting, and determining operation information in the classification device according to the first embodiment.

FIG. 15 is a diagram illustrating a computer that executes a classification program.

### DESCRIPTION OF EMBODIMENTS

Hereinafter, embodiments of a classification device, a classification method, and a classification program according to the present invention will be described in detail with reference to the appended drawings. The present invention is not limited to the embodiments.

### First Embodiment

In the following first embodiment, a configuration of a classification device and a flow of a process of the classification device according to the first embodiment will be described in order, and finally, advantageous effects of the first embodiment will be described.

[Configuration of Classification Device]

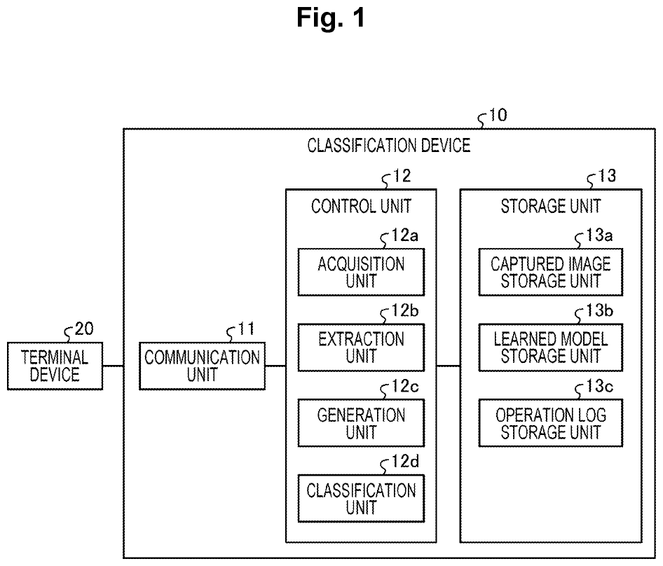

First, a configuration of a classification device according to the first embodiment will be described with reference to FIG. 1. FIG. 1 is a block diagram illustrating a configuration of the classification device according to the first embodiment.

As illustrated in FIG. 1, a classification device 10 is connected to a terminal device 20 via a network (not illustrated), and may be connected in a wired or wireless manner. The configuration illustrated in FIG. 1 is merely exemplary, and a specific configuration and the number of devices is not particularly limited.

The terminal device 20 is an information processing device operated by an operator. For example, the terminal device 20 is a desktop PC, a laptop PC, a tablet terminal, a mobile phone, a PDA, or the like.

Next, a configuration of the classification device 10 illustrated in FIG. 1 will be described. As illustrated in the drawing, the classification device 10 includes a communication unit 11, a control unit 12, and a storage unit 13. Hereinafter, a process of each unit included in the classification device 10 will be described.

The communication unit 11 controls communication related to various types of information. For example, the communication unit 11 controls communication related to various types of information exchanged with the terminal device 20 or an information processing device connected via a network. For example, the communication unit 11 receives, from the terminal device 20, operation event information regarding an operation event occurring when an operation of a mouse or a keyboard is performed. Here, the operation event information is, for example, various types of information including an occurrence time (time) of an operation event, an occurrence position, a type of event (a mouse click or a keyboard input), and cursor information.

The storage unit 13 stores data and programs necessary for various processes by the control unit 12 and includes a captured image storage unit 13a, a learned model storage unit 13b, and an operation log storage unit 13c. For example, the storage unit 13 is a semiconductor memory element such as a random access memory (RAM) or a flash memory, or a storage device such as a hard disk or an optical disc.

The captured image storage unit 13a stores a captured image acquired at regular time intervals (for example, 1 second) by the acquisition unit 12a to be described below. For example, the captured image storage unit 13a stores the captured time (hour) and the captured image in association. The captured image storage unit 13a may store captured images of an entire operation screen or may store some of the extracted captured images on the operation screen.

The learned model storage unit 13b stores a learned model for classifying types of GUI components operated in an operation event. The learned model stored in the learned model storage unit 13b outputs the types of GUI components operated in the operation event by using, for example, the captured image at the time of occurrence of the operation event or after the occurrence of the operation event and a difference image indicating a change occurring in the operation screen before and after the occurrence of the operation event as input data. Furthermore, the data input to the learned model is not limited to the captured images and the difference image, and may include images obtained by combining the cursor image and the captured images and cursor information including a value indicating a cursor state. It is assumed that the learned model stored in the learned model storage unit 13b is assumed to be learned in advance by an external device.

The learned model stored in the learned model storage unit 13b is not limited to one learned by an external device, and may be a learned model that is learned by the classification device 10, for example. In this case, for example, the classification device 10 further includes a learning unit that performs machine learning, and the learning unit performs the foregoing learning process in advance to generate a learned model.

The operation log storage unit 13c stores the captured image stored in the captured image storage unit 13a by the acquisition unit 12a in association with an occurrence time as captured images before, at, and after the occurrence of the operation event. For example, the operation log storage unit 13c stores the captured images before, at, and after the occurrence of the operation event, the difference image generated by the generation unit 12c, and the types of GUI components classified by the classification unit in association. The operation log storage unit 13c may store some of the operation event information including cursor information and an occurrence position in association.

The operation log storage unit 13c may store logs of all operation events performed by the terminal device 20, or may store only logs of predetermined operation events. The operation log storage unit 13c may store not only operation logs of operation events related to a specific business system but also logs of operation events of business using various applications such as an office application such as a mail, a web browser, Word, Excel, and PowerPoint at the same time, or may store logs for each operation event of a single application.

The control unit 12 includes an internal memory for storing programs and required data defining various processing procedures and the like, and performs various processes by using the programs and the data. For example, the control unit 12 includes an acquisition unit 12a, an extraction unit 12b, a generation unit 12c, and a classification unit 12d. Here, the control unit 12 is an electronic circuit such as a central processing unit (CPU) or a micro processing unit (MPU), or an integrated circuit such as an application specific integrated circuit (ASIC) or a field programmable gate array (FPGA).

The acquisition unit 12a acquires captured images of the operation screen before and after the occurrence of the operation event of the terminal device. For example, the acquisition unit 12a periodically acquires a captured image at regular intervals and stores the acquired captured image in the captured image storage unit 13a.

Then, the acquisition unit 12a may acquire three types of captured images at, before, and after occurrence of the operation event from the captured image storage unit 13a at a timing of occurrence of the operation event by the operator. Hereinafter, a case where three types of captured images at, before, and after occurrence of an operation event are acquired will be described as a main example.

For example, as a method of acquiring a captured image before the occurrence of the operation event, the acquisition unit 12a acquires the captured image at regular time intervals irrespective of presence or absence of occurrence of an operation event. When the operation event occurs, the captured image acquired before the occurrence of the operation event (before a predetermined time) is stored in the operation log storage unit 13c as the captured image before the occurrence of the operation event.

For example, as a method of acquiring a captured image after the occurrence of the operation event, the acquisition unit 12a may acquire a captured image after a certain period of time has passed after the occurrence of an operation event and store the captured image in the operation log storage unit 13c as a captured image after the occurrence of the operation event. The acquisition unit 12a may be a method of comparing an acquisition time of the captured image acquired at regular time intervals with an occurrence time of the operation event and associating the acquisition time with the occurrence time of the operation event later as captured images before the occurrence and after the occurrence.

The acquisition unit 12a may acquire the captured image, acquire cursor information displayed on the operation screen, and identify a shape of the cursor using the cursor information. For example, the acquisition unit 12a acquires a handle of a cursor at occurrence of an operation event and identifies the shape of the cursor by comparing the handle with a predefined handle of the cursor.

The acquisition unit 12a acquires an occurrence time of the event, an occurrence position of the event, and a type of event with regard to the event operated by the user. For example, at the occurrence of an operation event, the acquisition unit 12a acquires, from the terminal device 20, information regarding a type of event for identifying operation content such as a click operation or a key input, and information regarding an occurrence time of the operation event. Further, for example, when a click operation is performed, the acquisition unit 12a may acquire information regarding a position at which the operation event has occurred. When a key input is performed, the acquisition unit may acquire information regarding the type of operated key.

The extraction unit 12b compares the captured image before the occurrence of the operation event with the captured image after the occurrence of the operation event, and extracts the operation event when a difference occurs. For example, the extraction unit 12b compares each captured image at, before, and after the occurrence of the operation event with regard to a certain operation event, and extracts an event of the operation as an operation event in which a meaningful operation is likely to be performed when a difference has occurred in any of the captured images. Here, the operation event in which a meaningful operation is likely to be performed (hereinafter described as “meaningful operation event”) is an operation event in which an operation is likely to be performed on a GUI component.

As a captured image to be compared, the extraction unit 12b may use a captured image of the entire screen or may use an image obtained by cutting out a periphery of the occurrence position of the operation event from the captured image.

The generation unit 12c generates, as a difference image, a change occurring in the operation screen before and after the occurrence of the operation event by using the captured image acquired by the acquisition unit 12a. Specifically, the generation unit 12c generates, as a difference image, a change occurring in the operation screen before and after the occurrence of the operation event extracted by the extraction unit 12b.

For example, the generation unit 12c calculates a difference between the pixel values of the captured images before and after the occurrence of the operation event determined to be the operation event for the GUI component by the extraction unit 12b, and generates a difference image expressing the difference as an image by converting an absolute value of the difference into image data.

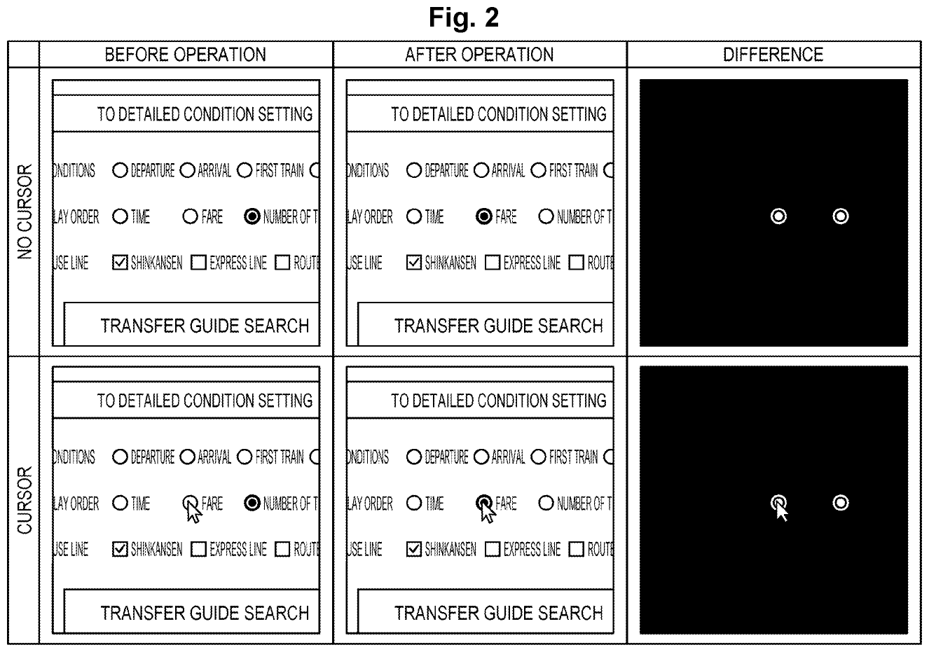

Here, an example of the difference image generated from the captured images before and after the operation of the GUI component will be described with reference to FIGS. 2 to 6. In FIGS. 2 to 6, a case of the captured image with no cursor and a case of the captured image with a cursor are illustrated.

FIG. 2 is a diagram illustrating an example of a difference image generated from the captured images before and after operation of GUI components of radio buttons. As illustrated in FIG. 2, the acquisition unit 12a acquires, as the captured image before operation, the captured image before the operation in which a radio button written as “the number of transfers” is checked.

Thereafter, after an operation event in which the operator selects a radio button written as “fare” occurs, the check display of the radio button written as “the number of transfers” disappears, and the acquisition unit 12a acquires the captured image after the operation in which the radio button written as “fare” is checked.

Then, the generation unit 12c calculates a difference between pixel values of the captured images before and after the operation, and generates a difference image including round marks of two radio buttons by converting an absolute value of the difference into image data.

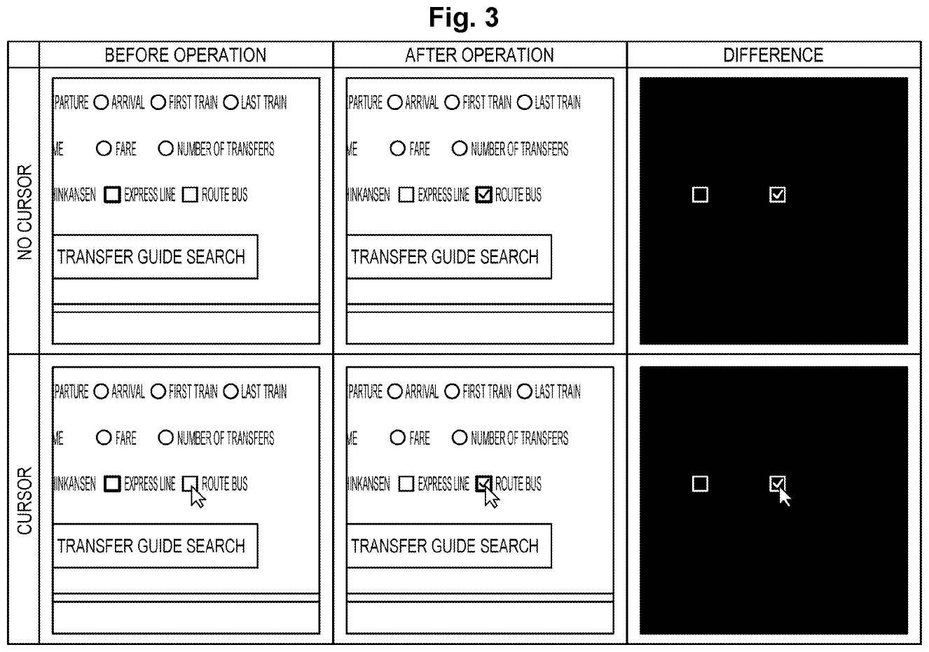

FIG. 3 is a diagram illustrating an example of the difference image generated from the captured images before and after the operation of the GUI components of the check box. As illustrated in FIG. 3, the acquisition unit 12a acquires, as the captured image before the operation, a captured image in which an edge of a check box written as “express line” is displayed in a thick frame.

Thereafter, after an operation event in which the operator selects the check box written as “route bus” occurs, the acquisition unit 12a acquires a captured image in which a check mark of the check box written as “express line” disappears, the edge of the check box written as “route bus” is displayed in a thick frame, and the check mark is displayed.

Then, the generation unit 12c calculates a difference between pixel values of the captured images before and after the operation, converts an absolute value of the difference into image data, and generates a difference image including square edges of two check boxes and a check mark of “route bus”.

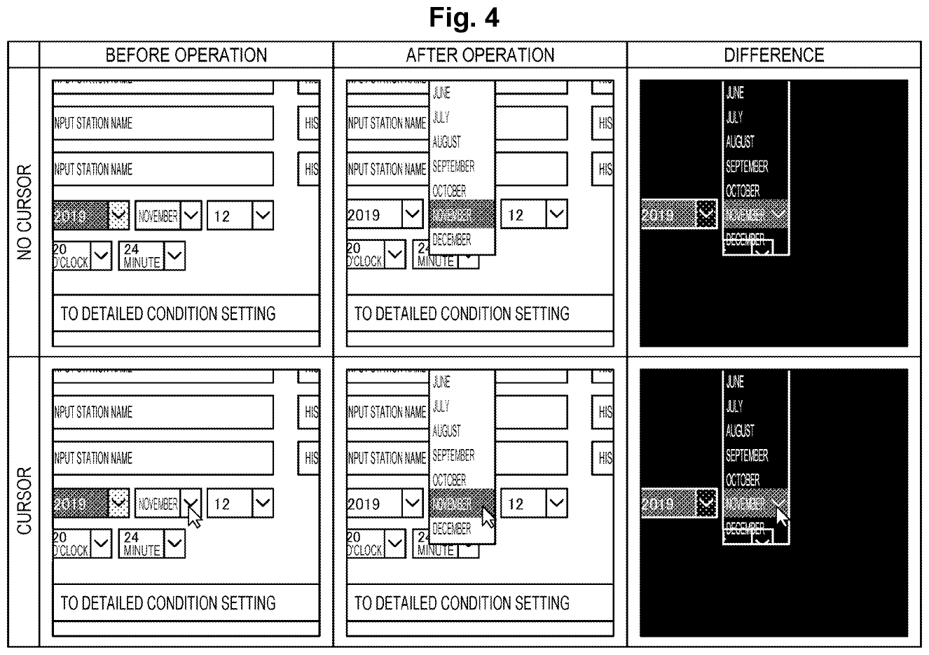

FIG. 4 is a diagram illustrating an example of the difference image generated from the captured images before and after the operation of the GUI component in the pull-down menu. As illustrated in FIG. 4, the acquisition unit 12a acquires a captured image in which a pull-down menu written as “2019” is selected as the captured image before operation.

Thereafter, after an operation event in which the operator clicks and selects a pull-down menu written as “November” with the cursor occurs, the acquisition unit 12a acquires a captured image after the operation in which coloring disappears by a selection of the pull-down menu written as “2019” and all the months are displayed in the pull-down menu written as “November” in a selective expression.

Then, the generation unit 12c calculates a difference between pixel values of the captured images before and after the operation, and generates a difference image including a pull-down menu written as “2019”, a pull-down menu written as “November”, and selection display of all other months by converting an absolute value of the difference into image data.

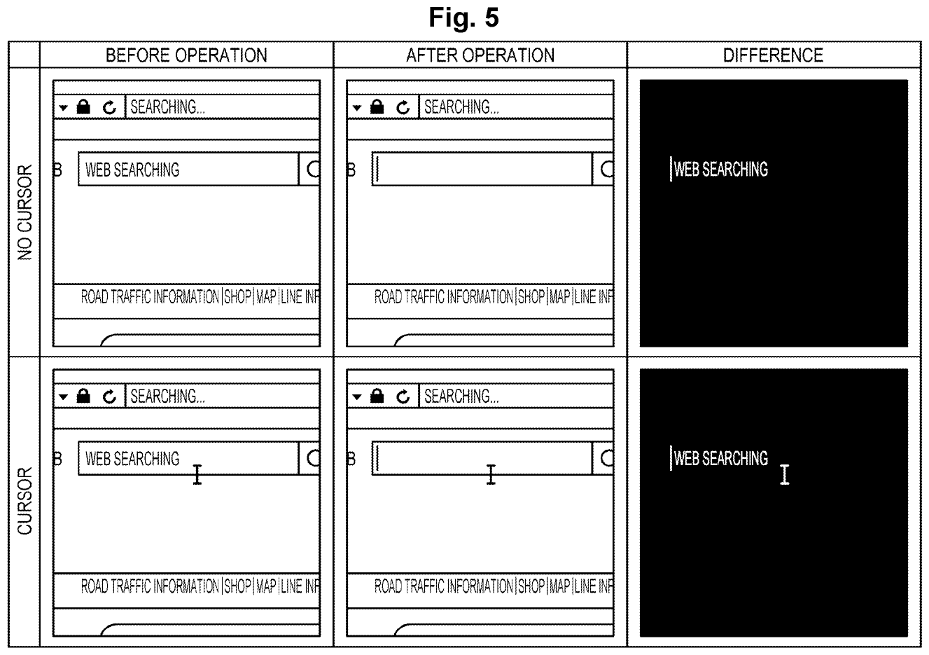

FIG. 5 is a diagram illustrating an example of the difference image generated from the captured images before and after the operation of the GUI component of the text box. As illustrated in FIG. 5, the acquisition unit 12a acquires, as a captured image before operation, a captured image in which GUI components of a text box written as “web searching” are displayed.

Thereafter, after an operation event in which the operator selects the GUI component of the text box written as “web searching” occurs, the acquisition unit 12a acquires the captured image after the operation in which characters of the text box written as “web searching” disappear and the cursor is displayed on the GUI component of the text box.

Then, the generation unit 12c calculates a difference between the pixel values of the captured images before and after the operation and generates a difference image including the characters of the text described as “web searching” and the cursor displayed on the GUI component of the text box by converting the absolute value of the difference into image data.

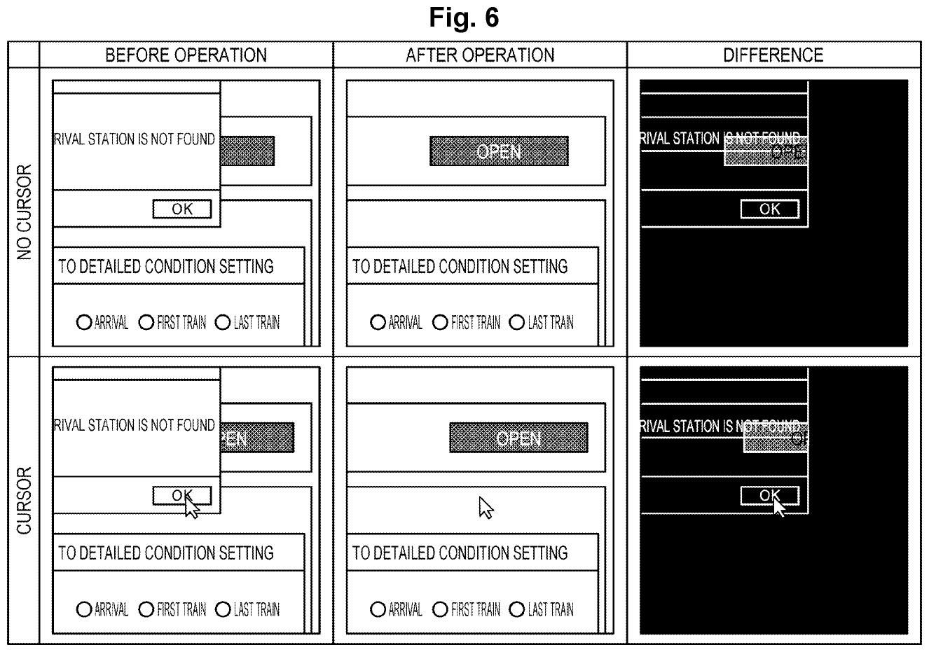

FIG. 6 is a diagram illustrating an example of the difference image generated from the captured image before and after the operation of the GUI component of the button. As illustrated in FIG. 6, the acquisition unit 12a acquires, as the captured image before the operation, a captured image in which an “OK” button is displayed in a tab written as “Arrival station is not found”.

Thereafter, after an operation event in which the operator presses an “OK” button occurs, the acquisition unit 12a acquires the captured image after the operation in which the tab written as “Arrival station is not found” disappears and the original screen is displayed.

Then, the generation unit 12c calculates a difference between pixel values of the captured images before and after the operation and generates a difference image including the tab written as “Arrival station is not found” and the original screen hidden by the tab by converting the absolute value of the difference into the image data.

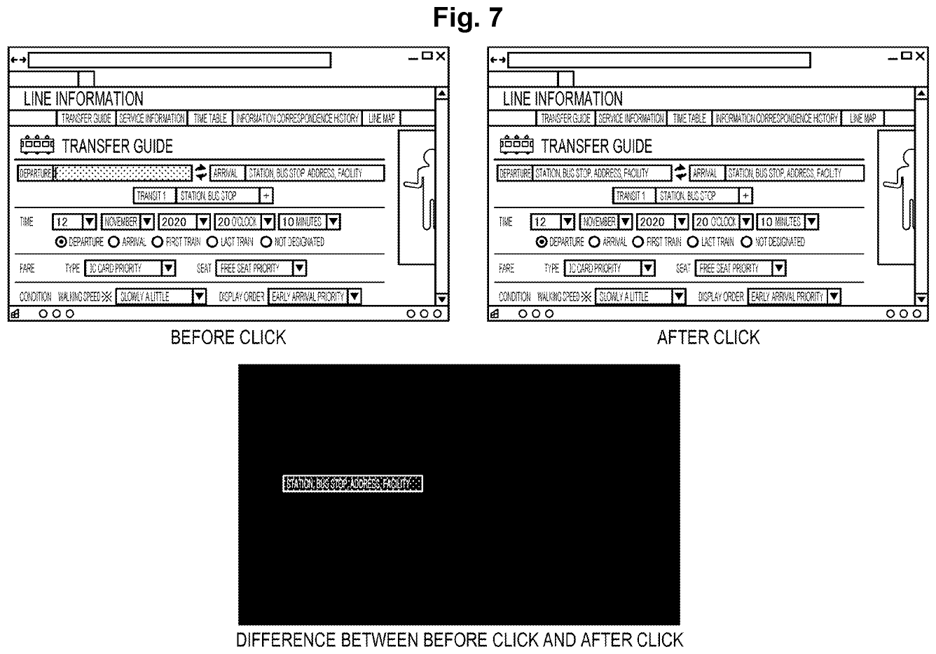

FIG. 7 is a diagram illustrating an example of a difference image generated from the captured image of the entire screen before and after the operation of the GUI component. In the example in which the difference image is generated, as described above, the case in which using the image obtained by cutting out the periphery of the occurrence position of the operation event from the captured image has been described. However, as illustrated in FIG. 7, the generation unit 12c may generate the difference image using the captured image of the entire screen.

Referring to FIG. 1 for description, the classification unit 12d classifies the types of GUI components operated in the operation event by using the difference image generated by the generation unit 12c. Here, the classification unit 12d classifies the types of GUI components and determines whether the operation event is a meaningful operation event. That is, when the classification unit 12d has a meaningful operation event, the classifiable GUI components are classified into, for example, any one of a “radio button”, a “check box”, a “pull-down menu”, a “text box”, a “button”, and a “link”. The classification unit 12d classifies the operation event as an “unmeaningful operation event” when the operation event is not a meaningful operation event.

For example, the classification unit 12d may accept the captured image and the cursor information acquired by the acquisition unit 12a and the difference image generated by the generation unit 12c as an input and may classify the types of GUI components operated in each operation event by using a learned model for classifying the types of GUI components operated in the operation event. This learned model is a learned model stored in the learned model storage unit 13b and is a learned model learned by using a predetermined machine learning algorithm and using a relationship between input data and an operated GUI component as training data.

The classification unit 12d may classify the types of GUI components operated in the operation event by using the difference image generated by the generation unit 12c and a shape of the cursor identified by the acquisition unit 12a.

When the classification unit 12d performs the classification, the classification unit 12d may use information regarding operation events performed before and after the operation event of a classification target for classification. That is, when a target operation event is a mouse click in order to focus on the text box, there is a high possibility that a subsequent operation event is a key input of characters or the like. Therefore, by using information indicating that the subsequent operation event is a key input, it is possible to expect an improvement in the classification accuracy of the target operation event. In this case, the classification unit 12d classifies the types of GUI components operated in the operation event by inputting the operation events performed before and after the operation event in addition to the captured images and the difference image to the learned model.

When the acquisition unit 12a can acquire identification information regarding a window, the classification unit 12d may use the identification information of the window for classification. For example, when the target operation event is pressing of a link, there is a high possibility that a page transition occurs due to the operation event. Accordingly, when the acquisition unit 12a can obtain the identification information of the window from the information indicating that the page transition has occurred after the operation event, it is possible to expect an improvement in the classification accuracy of the target operation event by using the identification information of the window. In this case, the classification unit 12d classifies the types of GUI components operated in the operation event by inputting the identification information of the window in addition to the captured images and the difference image to the learned model.

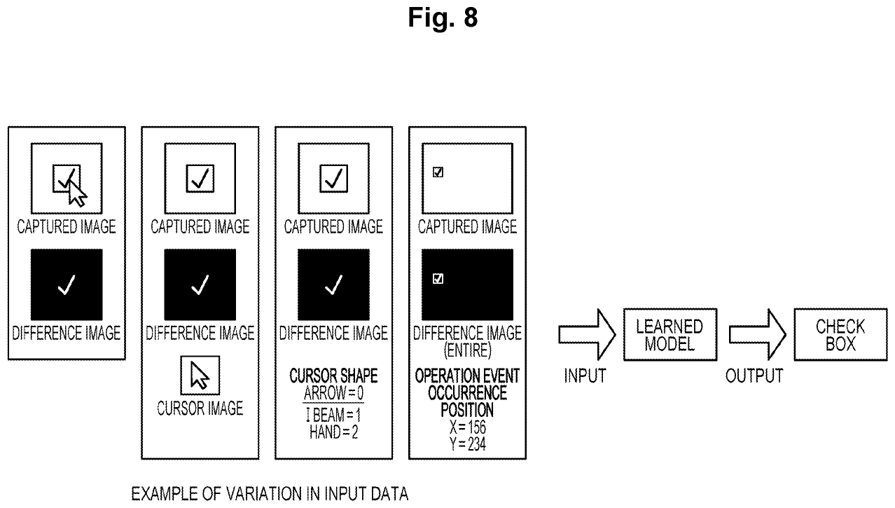

Here, an example of a variation in the input data to the learned model will be described. FIG. 8 is a diagram illustrating an example of a variation in input data to a learned model. As exemplified in FIG. 8, the classification unit 12d inputs the captured images acquired by the acquisition unit 12a and the difference image generated by the generation unit 12c to the learned model.

The classification unit 12d may input a cursor image in addition to the captured images and the difference image to the learned model. The classification unit 12d may input information regarding the shape of the cursor identified by the acquisition unit 12a to the learned model in addition to the captured images and the difference image. The classification unit 12d may input information regarding the occurrence position of the operation event acquired by the acquisition unit 12a to the learned model in addition to the captured images and the difference image.

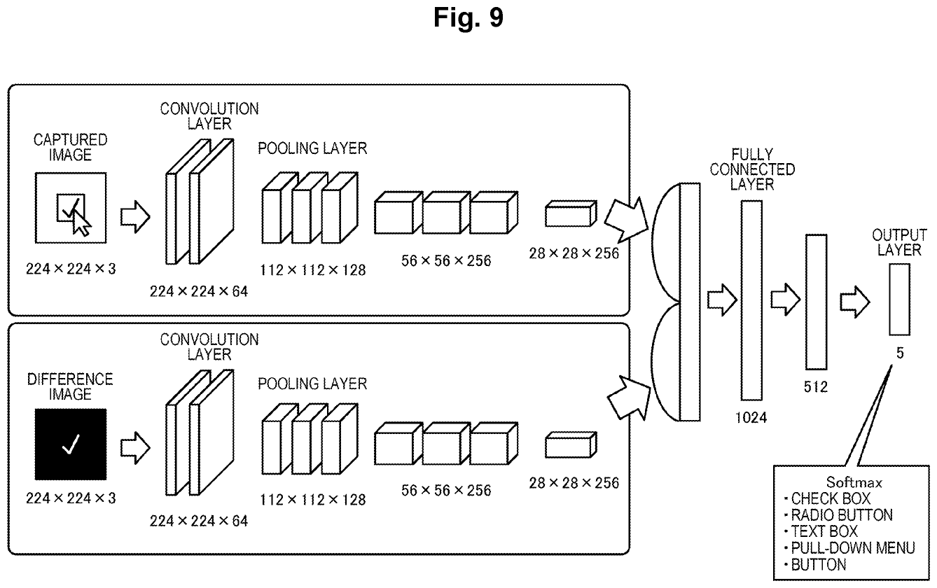

Next, a process of classifying the types of operated GUI components by inputting the captured images and the difference image to the learned model will be described. FIG. 9 is a diagram illustrating a process of classifying the types of operated GUI components by inputting the captured images and the difference image to the learned model. In the example of FIG. 9, a CNN has a hierarchical structure and includes a convolution layer, a pooling layer, a fully connected layer, and an output layer.

Here, learning of the learned model stored in the learned model storage unit 13b will be described. For the learned model for classifying the types of GUI components operated in the operation event, it is necessary to consider a situation in which, when there is a small amount of learning data, the learned model is likely to fall into over-learning which is a state in which the learned model is excessively adapted to the learning data and cannot cope with unknown data. For example, in order to robustly acquire a type of unknown GUI component from limited learning data, an external device that performs learning may use a dropout that inactivates several nodes of a specific layer when a relationship between input data and an operated GUI component is learned.

An external device that performs learning can generate a learning model with high classification accuracy by using a learned model for another related task when learning is performed with limited data. In order to robustly acquire the type of unknown GUI component from limited learning data, the external device that performs learning may perform transfer learning or fine tuning using a model in which the relationship between the image of the GUI component and the type of GUI component has been learned in advance when the relationship between the input data and the operated GUI component is learned.

[Example of Process by Classification Device]

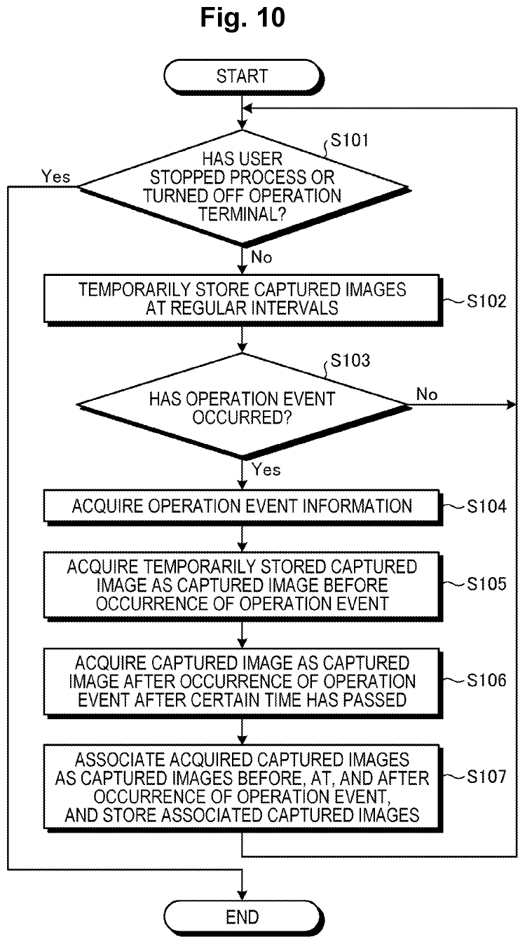

Next, an example of a processing procedure by the classification device 1 according to the first embodiment will be described with reference to FIGS. 10 to 13.

First, a process of storing a captured image will be described with reference to FIG. 10. FIG. 10 is a flowchart illustrating an example of a process of storing captured images for each operation event in the classification device according to the first embodiment.

As illustrated in FIG. 10, the acquisition unit 12a determines whether the user stopped the process or has turned off the terminal device 20 (step S101). As a result, when it is determined that the operator has stopped the process or has turned off the power of the terminal device (Yes in step S101), the acquisition unit 12a ends the process of this flow. Conversely, when the acquisition unit 12a determines that the operator has not stopped the process and has not turned off the power of the terminal device 20 (No in step S101), the acquisition unit 12a temporarily stores the captured images in the captured image storage unit 13a at regular intervals (step S102).

Then, the acquisition unit 12a determines whether an operation event has occurred (step S103). As a result, when an operation event has occurred (Yes in step S103), the acquisition unit 12a acquires operation event information (step S104). For example, the acquisition unit 12a acquires an occurrence time of the event, an occurrence position of the event, and a type of event for the operation event of the user, and stores them in the operation log storage unit 13c in association with the captured images at the time of the occurrence of the event. When the operation event has not occurred (No in step S103), the process returns to step S101.

Then, the acquisition unit 12a acquires the captured image before the occurrence of the operation event based on the occurrence time from the captured image temporarily stored in the captured image storage unit 13a in step S102 (step S105). Subsequently, the acquisition unit 12a acquires the captured image as the captured image after occurrence of the operation event after a certain time has passed (step S106). Then, the acquisition unit 12a associates the captured images before, at, and after the occurrence of the operation event based on the occurrence time from the acquired captured image, and stores the associated captured images in the operation log storage unit 13c (step S107). Thereafter, the process returns to step S101, and the flow of the foregoing process is repeated.

In addition, the acquisition unit 12a may store the process of storing the captured images in association with the operation event later in the classification device according to the first embodiment. For example, the acquisition unit 12a may independently acquire the captured images and the operation event, accumulate a certain amount of data of the captured images, and then associate the operation event with the captured images based on the occurrence time of the operation event.

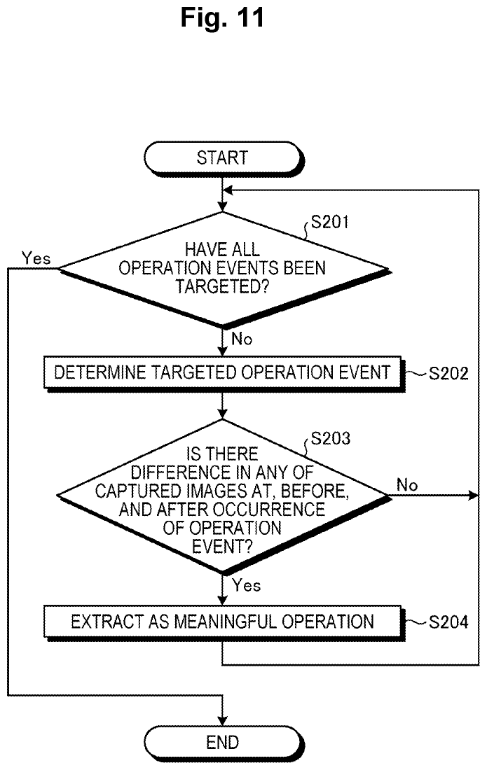

Next, a process of extracting the operation event for the GUI component from the captured images in the classification device according to the first embodiment will be described with reference to FIG. 11. FIG. 11 is a flowchart illustrating an example of a process of extracting the operation event on the GUI component from the captured images in the classification device according to the first embodiment.

As illustrated in FIG. 11, the extraction unit 12b determines whether all the operation events have been targeted (step S201). As a result, when it is determined that all the operation events have been targeted (Yes in step S201), the extraction unit 12b ends the process of this flow. When all the operation events have not been targeted (No in step S201), the extraction unit 12b determines a targeted operation event (step S202).

Subsequently, the extraction unit 12b determines whether there is a difference in any of the captured images at, before, and after the occurrence of the operation event (step S203). As a result, when the extraction unit 12b determines that there is no difference in any of the captured images at the time of occurrence of the operation event, before occurrence, and after occurrence (No in step S203), the process returns to step S201.

When the extraction unit 12b determines that there is the difference in any of the captured images at, before, and after the occurrence of the operation event (Yes in step S203), the extraction unit 12b extracts the targeted operation event as a meaningful operation (step S204). Thereafter, the process returns to step S201, and the flow of the above process is repeated.

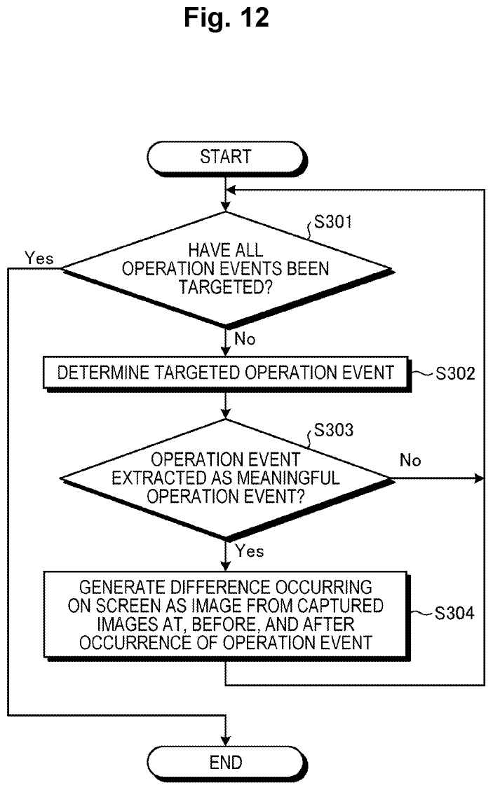

Next, a process of generating a difference image in the classification device according to the first embodiment will be described with reference to FIG. 12. FIG. 12 is a flowchart illustrating an example of a process of generating a difference image in the classification device according to the first embodiment.

As illustrated in FIG. 12, the generation unit 12c determines whether all the operation events have been targeted (step S301). As a result, when determining that all the operation events have been targeted (Yes in step S301), the generation unit 12c ends the process of this flow. When all the operation events have not been targeted (No in step S301), the generation unit 12c determines a target operation event (step S302).

Subsequently, the generation unit 12c determines whether the targeted operation event is an operation event extracted as a meaningful operation event (step S303). As a result, when the operation event is not extracted as the meaningful operation event (No in step S303), the generation unit 12c returns the process to step S301.

Then, when the generation unit 12c determines that the targeted operation event is an operation event extracted as a meaningful operation event (Yes in step S303), the generation unit 12c generates, as an image, a difference occurring on the screen from the captured images at, before, and after occurrence of the operation event (step S304). For example, at the occurrence of the operation event, the generation unit 12c generates a difference image by calculating a difference between pixel values of the captured images before and after the occurrence of the operation event and converts an absolute value of the difference into image data. Thereafter, the process returns to step S301, and the flow of the above process is repeated.

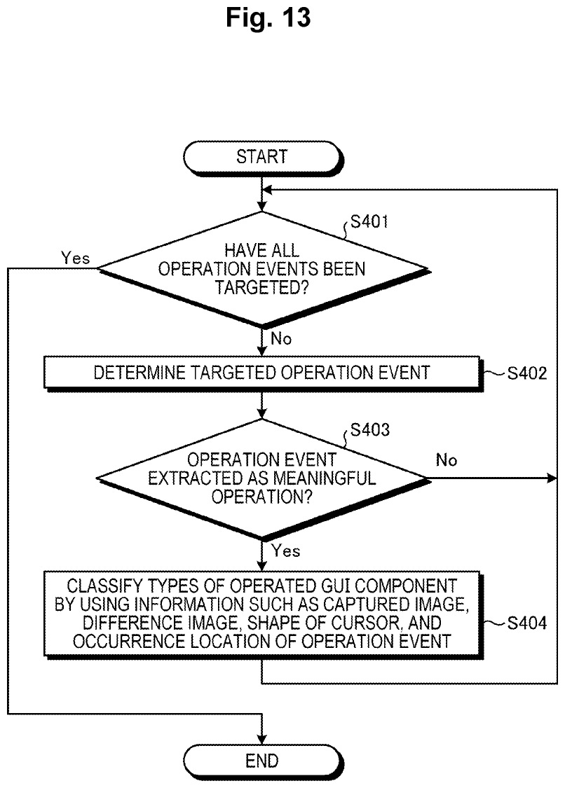

Next, a process of classifying the GUI components from the captured image for each operation event in the classification device according to the first embodiment will be described with reference to FIG. 13. FIG. 13 is a flowchart illustrating an example of a process of classifying the GUI components from the captured image for each operation event in the classification device according to the first embodiment.

As illustrated in FIG. 13, the classification unit 12d determines whether all the operation events have been targeted (step S401). As a result, when determining that all the operation events have been targeted (Yes in step S401), the classification unit 12d ends the process of this flow. When all the operation events have not been targeted (No in step S401), the classification unit 12d determines a targeted operation event (step S402).

Subsequently, the classification unit 12d determines whether the targeted operation event is an operation event extracted as a meaningful operation event (step S403). As a result, when the operation event is not extracted as a meaningful operation event (No in step S403), the classification unit 12d returns the process to step S401.

Then, when the classification unit 12d determines that the targeted operation event is an operation event extracted as a meaningful operation event (Yes in step S403), the classification unit classifies the types of operated GUI components by using information such as the captured image, the difference image, the shape of the cursor, and an occurrence location of the operation event (step S404). At this time, the classification unit 12d classifies the operation events that does not correspond to the meaningful operation on the GUI components into a category of “unmeaningful operation events”. Thereafter, the process returns to step S401, and the flow of the foregoing process is repeated.

### Advantageous Effects of First Embodiment

In this way, the classification device 10 according to the first embodiment acquires the captured images on the operation screen before and after the occurrence of the operation event of the terminal device 20. Then, the classification device 10 generates, as a difference image, a change occurring on the operation screen before and after the occurrence of the operation event by using the acquired captured image. Subsequently, the classification device 10 classifies the types of operated GUI components using the generated difference image. Accordingly, the classification device 10 can easily identify the operated GUI components and the types of GUI components irrespective of the execution environment of an application of the terminal device 20.

For example, in the classification device 10 according to the first embodiment, it is possible to identify the operated GUI component and determine the type of GUI component by using a changed operation portion and the appearance of the operation portion at a timing at which the user performs the operation. As a specific example, in the classification device 10 according to the first embodiment, it is possible to identify the operated GUI component and determine the type of GUI component by using the operation portion and the appearance of the operation portion in which there is a change in the difference on the screen occurring before and after the operation event including a change in the shape of the GUI component when the cursor is placed on the top of the GUI component, a change in the shape of the GUI component when the mouse is down, or a change occurring on the screen after a click.

For example, in the classification device 10 according to the first embodiment, it is possible to identify the operated GUI component and determine the type of GUI component by using the changed operation portion and the appearance of the operation portion, such as a standard arrow as a shape in a case where the cursor is located at a location where there is no GUI component, an I-beam as a shape in a case where the cursor is located on the text box, or a shape of a hand of a raised finger as a shape in a case where the cursor is located on a button.

The classification device 10 according to the first embodiment accepts the captured images acquired by the acquisition unit 12a and the difference image generated by the generation unit 12c as an input and classifies the types of GUI components operated in each operation event by using a learned model for classifying the types of GUI components operated in each operation event. Therefore, for example, the classification device 10 or an external device learns a feature common to the GUI components for the learned model, and thus, it is possible to robustly acquire the type of GUI component in a case in which the GUI component changes, or a type of unknown GUI component from limited learning data.

As described above, the classification device 10 can collect data serving as a reference used to generate an RPA scenario and improve the scenario by identifying the type of operated GUI component.

For example, in order to effectively introduce robotic process automation (RPA), it is important to ascertain an operation state on a terminal by a worker by displaying a flowchart format and find a range in which an automatable repeated operation is performed. When it is considered to provide a service or a product to a customer in business mainly in a terminal operation, an operation procedure of a system providing the same service or product is determined for each service or product and is shared by people in charge with a manual or the like.

In general, since a person in charge is expected to perform a process necessary to provide a service or a product in accordance with a manual, it is assumed that procedures for processing the same services or products are the same operation procedure. Therefore, in the related art, it is considered that a method of confirming a business procedure described in a business manual is effective as a method of ascertaining an actual business state. However, various irregular events that are not assumed in generation of the manual, such as a change in order content after ordering of a customer, a defective product, and an operation error of an operator, usually occur, and there is a problem that it is not practical to define all operation procedures in advance for these irregular events.

In the related art, it is difficult for a person in charge to memorize various operation methods, and it is not realistic to process all of them in accordance with a defined method. Therefore, there is a problem that the operation procedure is generally various for each case even for the same service/product, and it is difficult to ascertain an actual operation state from the operation manual.

In actual business, it is common to perform business while using not only a business system but also various applications such as an office application such as a mail, a web browser, Word, Excel, and PowerPoint. A method of acquiring an attribute value of a GUI component is different for each application. Therefore, in order to comprehensively ascertain business execution statuses of people in charge, it is necessary to develop a mechanism identifying acquisition and change portions of the attribute value of a GUI component according to execution environments of all applications used in business. However, in practice, development cost is very high and it is not realistic. Even if a specific application is developed, there is a problem that, when a specification change occurs with version upgrading of a target application, a modification corresponding to the specification change is required.

In recent years, a thin client environment has become widespread in companies for the purpose of effective use of computer resources and security measures. In the thin client environment, an operator does not install an application in a terminal device that is a terminal with which an operator directly performs an operation, and the application is installed in another terminal connected to the client terminal. An operation screen provided by an application is displayed as an image on the client terminal, and a person in charge operates the application on a connection destination side through the displayed image. In this case, since the operation screen is displayed as an image on the terminal with which the user actually performs the operation, it is not possible to identify a GUI component and a change portion from the client terminal.

In this way, in the related art, in business or a thin client environment in which various applications are used, it is not easy to collect, as a log, operations on GUI components performed on applications by people in charge. Therefore, in order to collect, as a log, the operations on the GUI components, it is necessary to identify the types of operated GUI components.

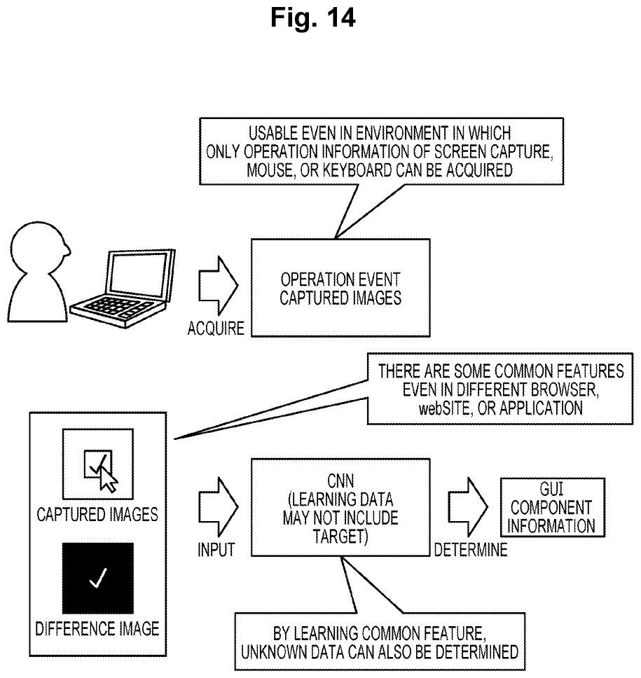

As illustrated in FIG. 14, the classification device 10 according to the present embodiment can be used in an environment in which only operation information of screen capturing, a mouse, and a keyboard can be acquired by identifying an operation log using a captured image of an operation screen of the terminal device 20. Even when different browsers, websites, and applications are used for each terminal device 20, unknown data can also be distinguished by causing captured images and a difference image to be learned by the CNN. Therefore, in the classification device 10 according to the present embodiment, it is possible to generally acquire the types of GUI components of an operation event by the operator and the flow of the operation irrespective of an execution environment of an application of the terminal device 20.

In addition, in business analysis for the purpose of introducing RPA, it is necessary to finally generate an RPA scenario. By identifying the types of operated GUI component, it is easy to reflect an analysis result in the RPA scenario.

For example, by identifying the types of operated GUI components, it is possible to visualize the number of operations for each component of the GUI component operated by a user, such as a text box or a radio button. Accordingly, for example, when there are many inputs in the text box and the text box can be patterned, the text box can be used as a reference for improving generation of a system such as a change to a selection box.

[System Configuration and Others]

Each of the constituents of each of the illustrated devices is functionally conceptual, and is not necessarily physically configured as illustrated. That is, a specific form of distribution and integration of devices is not limited to the illustrated form, and all or some of the devices can be functionally or physically distributed and integrated in any unit in accordance with various loads, usage conditions, and the like. Further, all or some of the processing functions performed in each device can be implemented by a CPU and a program to be analyzed and executed by the CPU or can be implemented as hardware by wired logic.

Among the processes described in the present embodiment, all or some of the processes described as being performed automatically can be performed manually, or all or some of the processes described as being performed manually can be performed automatically in accordance with a known method. The processing procedure, the control procedure, the specific name, and the information including various types of data and parameters that are illustrated in the literatures and the drawings can be freely changed unless otherwise specified.

[Program]

It is also possible to generate a program in which the process executed by the classification device 10 according to the foregoing embodiment is described in a computer-executable language. In this case, the computer executes the program, and thus the advantageous effects similar to those of the above-described embodiment can be obtained. Further, processes similar to those of the foregoing embodiment may be implemented by recording the program on a computer-readable recording medium and reading and executing the program recorded in the recording medium. Hereinafter, an example of a computer that executes a classification program that implements a function similar to that of the classification device 10 will be described.

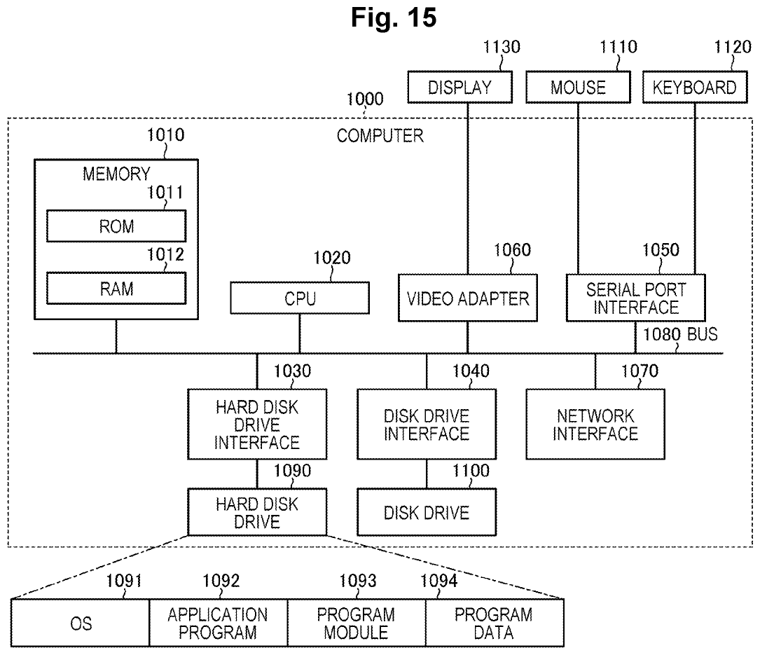

FIG. 15 is a diagram illustrating a computer that executes a classification program. As illustrated in FIG. 15, a computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1041. For example, a detachable storage medium such as a magnetic disk or an optical disc is inserted into the disk drive 1041. For example, a mouse 1110 and a keyboard 1120 are connected to the serial port interface 1050. For example, a display 1130 is connected to the video adapter 1060.

Here, as illustrated in FIG. 15, the hard disk drive 1090 stores, for example, an OS 1091, an application program 1092, a program module 1093, and program data 1094. Each table described in the above embodiment is stored in, for example, the hard disk drive 1090 or the memory 1010.

The classification program is stored in the hard disk drive 1090 as, for example, a program module in which a command executed by the computer 1000 is described. Specifically, the program module 1093 in which each process executed by the classification device 10 described in the above embodiment is described is stored in the hard disk drive 1090.

Data used for information processing by the classification program is stored as program data in, for example, the hard disk drive 1090. Then, the CPU 1020 reads the program module 1093 and the program data 1094 stored in the hard disk drive 1090 to the RAM 1012 as necessary, and executes each procedure described above.

The program module 1093 and the program data 1094 related to the classification program are not limited to being stored in the hard disk drive 1090, and may be stored in, for example, a detachable storage medium and read by the CPU 1020 via the disk drive 1041 or the like. Alternatively, the program module 1093 and the program data 1094 related to the classification program may be stored in another computer connected via a network such as a local area network (LAN) or a wide area network (WAN) and may be read by the CPU 1020 via the network interface 1070.

### REFERENCE SIGNS LIST

10 Classification device
11 Communication unit
12 Control unit
12a Acquisition unit
12b Extraction unit
12c Generation unit
12d Classification unit
13 Storage unit
13a Captured image storage unit
13b Learned model storage unit
13c Operation log storage unit
20 Terminal device

1. A classification device comprising:
an acquisition unit, including one or more processors, configured to acquire captured images of an operation screen before and after occurrence of an operation event of a terminal device;
a generation unit, including one or more processors, configured to generate, as a difference image, a change occurring on an operation screen before and after the occurrence of the operation event by using the captured images acquired by the acquisition unit; and
a classification unit, including one or more processors, configured to classify types of GUI components operated in the operation event by using the difference image generated by the generation unit.

2. The classification device according to claim 1,
wherein the acquisition unit is configured to: acquire the captured images, acquire information regarding a cursor displayed on an operation screen, and identify a shape of the cursor using the information of the cursor, and
wherein the classification unit is configured to classify the types of GUI components operated in the operation event by using the difference image generated by the generation unit and the shape of the cursor identified by the acquisition unit.

3. The classification device according to claim 1, wherein the classification unit is configured to: accept the captured images acquired by the acquisition unit and the difference image generated by the generation unit as inputs and classify the types of GUI components operated in each operation event by using a learned model for classifying the types of GUI components operated in the operation event.

4. The classification device according to claim 1, further comprising:
an extraction unit, including one or more processors, configured to compare each captured image of the captured images before the occurrence of the operation event with the captured image after the occurrence of the operation event, and extract the operation event when a difference occurs,
wherein the generation unit is configured to generate, as a difference image, a change occurring on the operation screen before and after occurrence of the operation event extracted by the extraction unit.

5. A classification method executed by a classification device, comprising:
acquiring captured images of an operation screen before and after occurrence of an operation event of a terminal device;
generating, as a difference image, a change occurring on an operation screen before and after the occurrence of the operation event by using the acquired captured images; and
classifying types of GUI components operated in the operation event by using the generated difference image.

6. A non-transitory computer-readable medium storing software comprising instructions executable by one or more computers which, upon such execution, cause the one or more computers to perform operations comprising:
acquiring captured images of an operation screen before and after occurrence of an operation event of a terminal device;
generating, as a difference image, a change occurring on an operation screen before and after the occurrence of the operation event by using the acquired captured images; and
classifying types of GUI components operated in the operation event by using the generated difference image.

7. The classification method according to claim 5, comprising:
acquiring the captured images;
acquiring information regarding a cursor displayed on an operation screen;
identifying a shape of the cursor using the information of the cursor; and
classifying the types of GUI components operated in the operation event by using the generated difference image and the identified shape of the cursor.

8. The classification method according to claim 5, comprising:
accepting the captured images acquired and the generated difference image generated as inputs; and
classifying the types of GUI components operated in each operation event by using a learned model for classifying the types of GUI components operated in the operation event.

9. The classification method according to claim 5, comprising:
comparing each captured image of the captured images before the occurrence of the operation event with the captured image after the occurrence of the operation event;
extracting the operation event when a difference occurs; and
generating, as a difference image, a change occurring on the operation screen before and after occurrence of the extracted operation event.

10. The non-transitory computer-readable medium according to claim 6, comprising:
acquiring the captured images;
acquiring information regarding a cursor displayed on an operation screen;
identifying a shape of the cursor using the information of the cursor; and
classifying the types of GUI components operated in the operation event by using the generated difference image and the identified shape of the cursor.

11. The non-transitory computer-readable medium according to claim 6, comprising:
accepting the captured images acquired and the generated difference image generated as inputs; and
classifying the types of GUI components operated in each operation event by using a learned model for classifying the types of GUI components operated in the operation event.

12. The non-transitory computer-readable medium according to claim 6, comprising:
comparing each captured image of the captured images before the occurrence of the operation event with the captured image after the occurrence of the operation event;
extracting the operation event when a difference occurs; and
generating, as a difference image, a change occurring on the operation screen before and after occurrence of the extracted operation event.
